(19) United States
(12) Patent Application Publication
(10) Pub. No.: US 2011/0044258 A1
(43) Pub. Date: Feb. 24, 2011

(54) METHOD OF MANAGEMENT OF RESOURCES FOR THE TRANSMISSION OF A DATA CONTENT, CORRESPONDING COMPUTER PROGRAM PRODUCT, STORAGE MEANS AND DEVICE

(75) Inventor: Patrice Nezou, Guignen (FR)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/445,714

(22) PCT Filed: Oct. 30, 2007
(86) PCT No.: PCT/EP07/61703

§ 371 Date: Nov. 11, 2010

(30) Foreign Application Priority Data
Dec. 1, 2006 (FR) 0610537

(51) Int. Cl. H04J 3/16; H04W 72/04

(52) U.S. Cl. 370/329; 370/468

(57) ABSTRACT

A method for the management of resources for transmission compliant with a communications protocol, in a communications network, of a first data stream between a source device (101, 102, 103) and at least one sink device (106), is implemented by a manager device and comprises step of a first allocation of a first value of bandwidth, called a reference value, for the transmission of the first stream. Such a method furthermore comprises the following steps: obtaining a piece of information representing a first temporary value of bandwidth for the transmission of the first stream, associated with a relevance time interval; making a second allocation, for a duration equal to the relevance time interval, of a second value, called a validated value, of bandwidth for the transmission of the first stream dependant on the first temporary value of bandwidth for the transmission of the first stream.

### 1. FIELD OF THE INVENTION

The field of the invention is that of the transmission of data contents in a communications network.

More specifically, the invention relates to the management of the reservation of resources during the simultaneous transmission of at least one stream in a communications network.

### 2. PRIOR ART SOLUTIONS

FIG. 2 presents a WLAN (Wireless Local Area Network) 1000 compliant with the IEEE802.11e communications network (as described in the standard referenced IEEE802.11e Std, especially part 11: “Wireless Medium Access Control (MAC) and physical layer (PHY) specifications: Medium Access Control Enhancements (MAC) for Quality of Service (QoS)”).

The classic wireless local area network 1000 hereinafter designated as WLAN 1000 is for example a home network in which data contents, especially of a multimedia type, are transmitted in keeping with Quality of Service (QoS) criteria.

The WLAN 1000 comprises an IEEE802.11e network compliant backbone network 100 to which are connected IEEE802.11e standard QoS Enhancement Station type terminals 101, 102, 103 (hereinafter called QSTA) which therefore implement QoS services as well as a IEEE802.11e standard QoS Enhancement Access Point type terminal 105 (hereinafter referenced QAP 105).

The QAP terminal 105 connected for example to a digital television set 106 implements a plurality of services including especially the control of the QSTA terminals 101 to 103 and of the QoS services.

The QSTA terminals 101 to 103 generate especially data streams (for example video streams) at variable bit rates (VBR) which they transmit to the QAP terminal 105. A variable bit rate data stream (hereinafter called a VBR stream) is characterised by its mean bit rate, the peak value of its bit rate and its maximum packet size. VBR streams are transmitted with a variable bit rate and therefore call for the setting up of a bandwidth adapted to their transmission.

In order to transmit a VBR stream suitably in a wireless communications network, it is necessary to:
optimize the bandwidth for the transmission of this stream;
minimise the waiting time for the transmission of this stream;
minimise the packet loss during the transmission of this stream.

Thus, a wireless network of this kind necessitates the implementation of QOS services to optimise the bandwidth and minimise the waiting time. For example, the IEEE 802.11e enables a part of these pre-requisites to be fulfilled in the context of resources reservation for the stream, in defining QSTA terminals and QAP terminals.

The IEEE802.11e standard makes it possible to obtain QoS in the WLAN 1000. The QAP terminal 105 fulfils a hybrid co-ordination function (HCF). This function may be implemented in the form of first and second channel access functions described here below and illustrated by FIG. 2. FIG. 2 is a drawing of a MAC (<<Medium Access Control>>) structure 201 of the MAC architecture of the IEEE802.11e standard.

The first channel access function is the Enhanced Distributed Channel Access (EDCA) function. This EDCA function is a channel access function using a network architecture with contention type management (also called DiffServ type management). After obtaining the assent of the QAP terminal 105, each QSTA terminal 101 to 103 tries to access the support with a waiting time or backoff time mechanism.

The second channel access function is the HCF controlled channel access function (or HCCA). This HCCA function is the invitation-to-send mechanism controlled by the QAP 105 and using a network architecture with reservation type management (also called “IntServ”). This function is based on the concept of transmission opportunity (for example through the TXOP interval). TXOP(i) is defined as the time interval (defined by a start time and a duration) for which a terminal “i” is entitled to initiate transmission on the WLAN 1000. This function is used especially for audio and video transmission.

The TXOP time intervals (or time windows) 204 are reserved by the QAP terminal at the request of a QSTA terminal 101, 102, 103 by means of a dedicated QoS message called a TSPEC message 205 of a standard type.

A standard type of TSPEC message gives all the information used to described an audio-video stream (as explained in the IEEE802.11e standard). Through this TSPEC message, the QAP terminal 105, in a first stage, determines the minimum value of the service intervals (SI) 202 necessary to transmit all the streams to be transmitted. Then, the QAP terminal 105 chooses the sub-multiple of the MAC structure of the IEEE802.11e standard suited to corresponding to the minimum value of the length of the service intervals.

After a contention-free phase (or CFP) 203 exclusively reserved for the HCCA function, there is a contention phase (CP) 207 during which there is an alternation of periods dedicated to the EDCA function 205 and controlled access periods (CAP) 208 dedicated to the HCCA function.

As soon as the minimum value of the service intervals is determined, the QAP terminal 105 evaluates the TXOP interval allocated to the set of audio-video streams in taking account of the parameters of each audio-video stream.

The MAC architecture of the IEEE802.11e standard is simple and efficient if each audio-video streams to be transmitted complies strictly with its QoS prerequisites.

However, certainly real-time applications may lead to the generation of VBR streams (transmitted therefore with variable bit rates) and, in this case, this architecture may cause the average transmission queue length to be increased.

Furthermore, even if an average bit rate is defined for each of the streams of a set of VBR streams, a bit rate peak for a stream of this kind cannot be absorbed by the standard TXOP mechanism.

In conclusion, in a network such as the WLAN 1000 compliant with the IEEE802.11e standard, in order to obtain the management of the bandwidth during simultaneous transmission of several VBR streams, it may conventionally be chosen to:
base the resource reservation for these VBR streams on their peak bit rate values; however, this leads to an increase in waiting times for the transmission of these streams;
base the resource reservation for these VBR streams on their mean bit rate values; however, this generally leads to packet losses during the transmission of these streams and especially during the bit rate peaks.

Furthermore, making a preliminary definition, for each VBR stream in a set of VBR streams, of a fixed value of bandwidth allocated to this VBR stream entails bandwidth losses in the transmission of these streams when it subsequently transpires that a stream needs less bandwidth.

### 3. GOALS OF THE INVENTION

The invention is aimed especially, in at least one embodiment, at overcoming these drawbacks of the prior art.

More specifically, it is a goal of the invention in at least one of its embodiments to provide a technique for the management of resource allocation during the simultaneous transmission of at least one VBR type stream in a communications network by which the use of the bandwidth allocated to the transmission of this stream or these streams can be optimized.

It is another goal of the invention, in at least one of its embodiments to implement a technique of this kind to:

optimise bandwidth,

minimise waiting time or backoff time,

minimise packet loss,

during the transmission of this stream or these streams.

It is another goal of the invention, in at least one of its embodiments, to implement a technique of this kind enabling the transmission of more streams simultaneously in the network.

It is yet another goal of the invention, in at least one of its embodiments, to implement a technique of this kind that is compatible with the recommendations of the protocols implemented and enables cohabitation in one and the same network of devices implementing the invention with devices simply complying with the recommendations of the protocols implemented.

It is yet another goal of the invention in at least one of its embodiments to implement a technique of this kind that is simple to implement and low in cost.

### 4. SUMMARY OF THE INVENTION

One particular embodiment of the invention proposes a method for the management of resources for transmission compliant with a communications protocol, in a communications network, of a first data stream between a source device and at least one sink device, said method being implemented by a manager device and comprising a step of a first allocation of a first value of bandwidth, called a reference value, for the transmission of the first stream.

According to the invention, the method furthermore comprises the following steps:
obtaining a piece of information representing a first temporary value of bandwidth for the transmission of the first stream, associated with a relevance time interval;
making a second allocation, for a duration equal to the relevance time interval, of a second value, called a validated value, of bandwidth for the transmission of the first stream dependant on the first temporary value of bandwidth for the transmission of the first stream.

According to the general principle of invention, during the transmission of a stream in the network, an optimised value (or validated value) of bandwidth is allocated according to time interval (or relevance time interval) to this transmission instead of a default bandwidth (or reference bandwidth) that is constant for the entire duration of the transmission of the stream.

Thus, a management of the allocation of resources is obtained during simultaneous transmission of at least one stream, for example a VBR type stream, in a communications network by which it is possible to optimise the use of the bandwidth allocated to the transmission of this stream or these streams.

Thus, this management enables the dynamic reallocation of a new bandwidth for the transmission of each stream.

Furthermore, this management makes it possible to:
optimise bandwidth
minimise waiting time or backoff time,
minimise packet loss,
   during the transmission of this stream or these streams.

Moreover, through the technique of the invention, it is possible to obtain the simultaneous transit of more streams in the network since the available and unutilized bandwidth in the network can be reduced.

Furthermore, the method of the invention is based on transmission protocols such as the IEEE802.11e protocol.

Furthermore, the method of the invention can be used to implement QoS resource reservation in a communications network in a way that is fully transparent to the user.

Advantageously, the method comprises a step for determining the validated value, said step for determining the validated value being such that if the first temporary value is lower than the reference value, then the validated value is equal to the first temporary value.

Preferably, the difference between the reference value and the first temporary value is added to a value of bandwidth unutilized in the network during the relevance time interval.

Thus, this makes all the bandwidth unutilized during the relevance time interval available for the transmission of streams requiring temporarily additional bandwidth.

According to a preferred characteristic of the invention, if the first temporary value is greater than the reference value, then the step for determining the validated value includes a step for determining a bandwidth value, called a difference value, equal to the difference between the first temporary value and the reference value.

Advantageously, the method furthermore comprises a step for determining a value of bandwidth unutilized in the network in said relevance time interval.

Preferably, said step for determining a value of bandwidth unutilized in said relevance time interval comprises a preliminary step for obtaining at least one piece of information representing at least one second temporary value of bandwidth for the transmission of at least one second stream in said relevance time interval.

Thus, a redistribution will be carried out first of all of the bandwidth not used by the transmission of streams requiring a value of bandwidth lower than their reference bandwidth value during the relevance time interval.

According to an advantageous characteristic of the invention, said step for determining the validated value is performed according to a policy of redistribution of said value of bandwidth unutilized in the network in said relevance time interval, said policy taking account of a value of classification associated with each stream being transmitted in the communications network.

Thus, the invention makes it possible to reduce the bandwidth that is available and unutilized in the network.

According to a first embodiment, for a given stream, said classification value is obtained from at least one piece of information representing the difference between a reference value and at least one temporary value, for a given time interval, of bandwidth for the transmission of said stream.

Thus, it is possible for example to favour streams than do not often request additional bandwidth for their transmission.

According to a second embodiment, said value of classification of the stream is increased when the temporary value is greater than the reference value for the transmission of said stream.

Advantageously, for a given stream, said classification value is obtained from at least one piece of information representing the difference between a reference value and at least one validated value, for a given time interval, of bandwidth for the transmission of said stream.

Preferably, said value of classification of a stream is reduced when the temporary value is lower than the reference value for the transmission of said stream.

According to one characteristic of the invention, the validated value is equal to the first temporary value if the difference value is lower then said value of bandwidth unutilized in the network, in said relevance time interval, that is remaining once each stream undergoing transmission in the communications network, whose classification value is greater than that of the first stream, has been taken into account in a step of redistribution of said value of bandwidth unutilized in the network in said relevance time interval.

According to a first embodiment of the invention, said piece of information representing a first temporary value of bandwidth is computed by the manager device according to a piece of information representing a predicted value of bandwidth, said piece of information representing a predicted value of bandwidth being transmitted to the manager device by the source device.

Thus, the management of resources is quasi-centralised at the manager device.

According to a second embodiment of the invention, said piece of information representing the first temporary value of bandwidth is computed by the source device according to a piece of information representing a predicted value of bandwidth, and then said piece of information representing a first temporary value of bandwidth is transmitted to the manager device.

Thus, the computation capacity needed to determine the temporary value is at least partly distributed in the communications network.

Advantageously, the reference value depends on a level of transmission priority associated with said first stream.

Thus, for a high-priority stream, the credit index will be high, because of the reception of numerous smaller delta-type TSPEC messages, which will favour it in the classification of the streams made by the QAP for the allocation of the TXOPs, relative to the low-priority streams, for which numerous greater delta-type TSPEC messages are received.

Preferably, the communications protocol is the IEEE802.11e protocol, the manager device is a QAP terminal and the source device is a QSTA terminal.

Thus, for example, the invention is compatible with the recommendations of the IEEE802.11e protocol implemented because it can be based on the use of TSPEC messages.

The invention also relates to a method for the management of resources for transmission compliant with a communications protocol, in a communications network, of a first data stream between a source device and at least one sink device,

said method being implemented by the source device and comprising a step to obtain a piece of information representing a value, called a reference value, of bandwidth for the transmission of the first stream.

According to the invention, the management method furthermore comprises the following step:
determining a piece of information representing a temporary value of bandwidth for the transmission of a stream for a relevance time interval as a function of a piece of information representing at least one predicted value of bandwidth,

and, if the temporary value differs from the reference value, the method comprises the following step:
the transmission, to a manager device, of said piece of information representing a temporary value of bandwidth for the transmission of the first stream.

Advantageously, in the transmission step, there is also transmitted an indication of the relevance time interval associated with a piece of information representing a temporary value of bandwidth for the transmission of the stream.

Preferably, said piece of information representing at least one predicted value of bandwidth is transmitted to the source device by a video encoder.

According to a preferred characteristic of the invention, the reference value depends on a transmission priority level associated with said stream.

Thus, for a high-priority stream, the credit index will be high, because of the sending of numerous smaller delta-type TSPEC messages, which will favour it in the classification of the streams made by the QAP for the allocation of the TXOPs, relative to the low-priority streams, for which numerous greater delta-type TSPEC messages are received.

Advantageously, the method furthermore comprises the following step:
reception of a piece of information on the allocation of resources for the relevance time interval.

Preferably, if the piece of information on allocation of resources indicates an allocation of resources lower than the temporary value, then during the relevance time interval, the source device transmits a quantity of data corresponding to the reference value of bandwidth for the transmission of said stream.

Advantageously, the communications protocol is the IEEE802.11e protocol, the manager device is a QAP terminal and the source device is a QSTA terminal.

The invention also relates to a computer program product that can be downloaded from a communications network and/or recorded on a computer-readable medium and/or executed by a processor, comprising computer code instructions for the implementation of at least one of the resource management methods as described here above.

The invention also relates to a storage means, totally or partially detachable as the case may be, readable by a computer, storing a set of instructions executable by said computer to implement at least one of the resource management methods as described here above.

The invention also relates to a manager device comprising means for the management of resources for transmission compliant with a communications protocol, in a communications network, of a first data stream between a source device and at least one sink device, said resource management means comprising means of first allocation of a first value, called a reference value, of bandwidth for the transmission of the first stream.

According to the invention, said resource management means furthermore comprise:
means of obtaining a piece of information representing a first temporary value of bandwidth for the transmission of the first stream, associated with a relevance time interval;
means of second allocation, for a duration equal to the relevance time interval, of a second value, called a validated value, of bandwidth for the transmission of the first stream dependant on the first temporary value of bandwidth for the transmission of the first stream.

Preferably, said resource management means furthermore comprise means for determining the validated value, said means for determining the validated value being such that if the first temporary value is lower than the reference value, then the validated value is equal to the first temporary value.

Advantageously, said resource management means comprise means for adding the difference between the reference value and the first temporary value to a value of bandwidth unutilized in the network during the relevance time interval.

According to an advantageous characteristic of the invention, said means for determining the validated value include means for determining a bandwidth value, called a difference value, equal to the difference between the first temporary value and the reference value, said means for determining a bandwidth value being activated if the first temporary value is greater than the reference value.

Preferably said resource management means furthermore comprise means for determining a value of bandwidth unutilized in the network in said relevance time interval.

Advantageously, said means for determining a value of bandwidth unutilized in said relevance time interval comprise means for obtaining at least one piece of information representing at least one second temporary value of bandwidth for the transmission of at least one second stream in said relevance time interval.

According to an advantageous characteristic of the invention, said means for determining the validated value take account of a policy of redistribution of said value of bandwidth unutilized in the network in said relevance time interval, said policy taking account of a value of classification associated with each stream being transmitted in the communications network.

Preferably, for a given stream, said classification value takes account of at least one piece of information representing the difference between a reference value and at least one temporary value, for a given time interval, of bandwidth for the transmission of said stream.

According to an advantageous characteristic of the invention, the manager device comprises means for increasing said value of classification of the stream when the temporary value is greater than the reference value for the transmission of said stream.

Preferably, for a given stream, said classification value takes account of at least one piece of information representing the difference between a reference value and at least one validated value, for a given time interval, of bandwidth for the transmission of said stream.

Advantageously, the manager device comprises means for reducing said value of classification of a stream, said reducing means being activated when the temporary value is lower than the reference value for the transmission of said stream.

Advantageously, the manager device comprises means of redistribution of said value of bandwidth unutilized in the network in said relevance time interval, and the validated value is equal to the first temporary value if the difference value is lower then said value of bandwidth unutilized in the network, in said relevance time interval, that is remaining once each stream in transmission in the communications network, whose classification value is greater than that of the first stream, has been taken into account by the means of redistribution of said value of bandwidth unutilized in the network in said relevance time interval.

Preferably, the manager device comprises means to compute said piece of information representing a first temporary value of bandwidth, said computation means taking account of a piece of information representing a predicted value of bandwidth, and the manager device comprises means of reception of said piece of information representing a predicted value of bandwidth.

According to an advantageous mode of implementation of the invention, the source device comprises means of computation of said piece of information representing a first temporary value of bandwidth, said computation means taking account of a piece of information representing a predicted value of bandwidth, the manager device comprising information representing a first temporary value of bandwidth.

Preferably, the reference value depends on a level of transmission priority associated with said first stream.

Advantageously, the communications protocol is the IEEE802.11e protocol, the manager device is a QAP terminal and the source device is a QSTA terminal.

The invention also relates to a source device comprising means of management of resources for transmission compliant with a communications protocol, in a communications network, of a data stream between a source device and at least one sink device,

said resource management means comprising means for obtaining a piece of information representing a value, called a reference value, of bandwidth for the transmission of the first stream.

According to the invention, the resource management means furthermore comprise:
means for determining a piece of information representing a temporary value of bandwidth for the transmission of a stream for a relevance time interval as a function of a piece of information representing at least one predicted value of bandwidth,

and the resource management means furthermore comprise means for determining whether the temporary value differs from the reference value and means of transmission, to a manager device, of said piece of information representing a temporary value of bandwidth for the transmission of the first stream, said transmission means being activated in the event of a positive determination.

Preferably, said transmission means also comprise means of transmission of an indication of the relevance time interval associated with the piece of information representing a temporary value of bandwidth for the transmission of the stream.

Advantageously, the source device comprises means of reception of said piece of information representing at least one predicted value of bandwidth.

Preferably, the reference value depends on a transmission priority level associated with said stream.

According to an advantageous characteristic of the invention, said resource management means furthermore comprise:
means of reception of a piece of information on the allocation of resources for the relevance time interval.

Advantageously, the source device comprises means of transmission, during the relevance time interval, of a quantity of data corresponding to the reference value of bandwidth for the transmission of said stream, said transmission means being activated if the piece of information on allocation of resources indicates an allocation of resources lower than the temporary value.

Preferably, the communications protocol is the IEEE802.11e protocol, the manager device is a QAP terminal and the source device is a QSTA terminal.

### 5. LIST OF FIGURES

Other characteristics and advantages of the invention shall appear from the following description of several preferred embodiments, given by way simple illustrative and non-exhaustive examples and from the appended drawings, of which:

FIG. 1 is a drawing of a WLAN type wireless local area network compliant with the IEEE802.11e protocol in which it is possible to implement the transmission method according to an embodiment of the invention;

FIG. 2 illustrates the MAC (Medium Access Control) architecture of the IEEE802.11e standard;

FIG. 3 is a flow chart of the essential steps of an algorithm for the generation of a TSPEC message according to the particular embodiment of the invention;

FIG. 4 is a flow chart of the essential steps of a processing algorithm, implemented by a HCCA-type scheduler included in the QAP terminal, of a MAC structure according to the particular embodiment of the invention;

FIG. 5 is a flow chart of the essential steps of a processing algorithm, implemented by the QAP terminal, of a TSPEC message received in the context of the transmission of the stream according to the particular embodiment of the invention;

FIG. 6 is a flow chart of the essential steps of a process for the specific processing of a delta-type TSPEC message received in the context of the transmission of the given stream according to the particular embodiment of the invention;

FIG. 7 is a flow chart of the essential steps of a process for the specific processing of a smaller delta-type TSPEC message received in the context of the transmission of the given stream according to the particular embodiment of the invention;

FIG. 8 is a flow chart of the essential steps of a process for the specific processing of a greater delta-type TSPEC message received in the context of the transmission of the given stream according to the particular embodiment of the invention;

FIG. 9 presents an example of implementation of the table of credit indices according to the particular embodiment of the invention;

FIG. 10 is a flow chart of the essential steps of an algorithm for updating the table of credit indices by the QAP terminal according to the particular embodiment of invention.

### 6. DESCRIPTION OF AN EMBODIMENT OF THE INVENTION

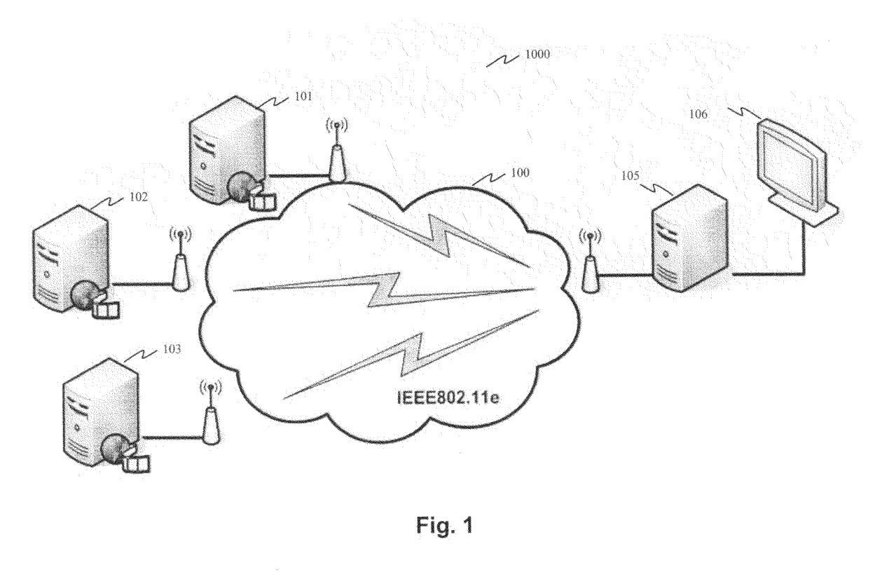

A description is provided here below of the transmission resource management method (hereinafter also caused a transmission method) according to one particular embodiment of the invention in the context of the IEEE802.11-compliant WLAN 1000 of FIG. 1. The WLAN also has at least one audio-video encoder not shown in FIG. 1. Here below, it is assumed that all the QSTA terminals of the network 1000 use the same type of audio-video encoder. Naturally, according to one variant of this particular embodiment, each QSTA terminal may include its own audio-video encoder.

The WLAN 1000 is for example a home network. Naturally, the network 1000 may implement any communications protocol other than the IEEE 802.11e protocol (for example a IEEE 802-x type protocol or even any other communications protocol enabling a dynamic allocation of bandwidth).

The WLAN 1000 comprises terminal devices that are visible to the user (for example multimedia terminals of the WLAN 1000 which are directly controlled by the user) and network infrastructure apparatuses used to link up between these terminal devices.

It will be noted that the WLAN 1000 may be a home network as well as a local area network of a firm, and may be partially or totally constituted by wireless segments (for example compliant with the “Wifi” or “Bluetooth” (registered marks) standards.

Naturally, the invention can be implemented in any type of wireless or wire-based type of communications network.

A description is provided here below of the transmission resource management method according to the particular embodiment of the invention mentioned here above in a particular example of the transmission of audio-video VBR streams from at least one of the QSTA terminals 101, 102, 103 (source device or devices) to the television set 106 (sink device) through the QAP terminal 105 (manager device) belonging to the WLAN 1000.

The method of transmission according to the invention (described here below in greater detail) is implemented in the form of a software program and/or or a plurality of software sub-programs (comprising a plurality of algorithms described here below) executed in several machines of the WLAN 1000.

Thus, to efficiently transmit the VBR streams (generated by the QSTA terminals), which imply a variable bandwidth consumption in the WLAN 1000, the present invention proposes to implement a technique for the dynamic management of the allocation of the bandwidth by which it is possible to dynamically manage the bandwidth allocated to the transmission of each VBR stream.

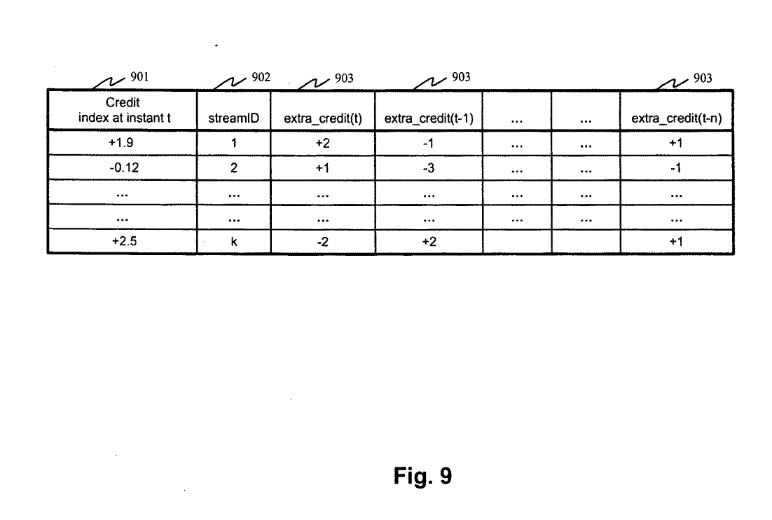

To this end, this technique implements a table of credit indices (here below described with reference to FIG. 9) built from the difference between the predicted bit rate (or the progress of the predicted necessary bandwidth) and the initially reserved bit rate (i.e. a reference value) for the transmission of the VBR streams. This technique also implements validation time windows for the transmission of the VBR streams obtained from the analyses of progress of the bit rate of the audio-video encoder or encoders.

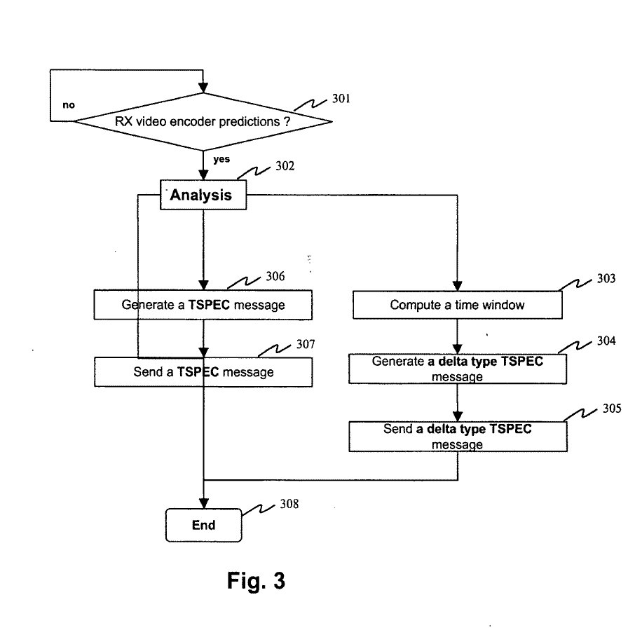

Thus, in order to transmit one of the VBR streams, a QSTA terminal 101, 102, 103 obtains these predictions of bit rates and validation time windows from the audio-video encoder. Then, using the algorithm described here below with reference to FIG. 3, it generates a dedicated message called a TSPEC message of a delta type (described here below) which it then sends to the QAP terminal 105 (which acts as a manager device as understood in the present invention) in order to transmit this information (predictions of bit rate and validation time windows) to it.

Naturally, any device other than the QAP terminal may act as manager device as understood in the present invention.

The progress of the predicted bit rate may be obtained in different ways as explained by Xiaoying Liu, Xiaodong Liu, Qionghai Dai and Peng Tan in “VBR MPEG video traffic prediction based on intelligent integrated model”, Visual Communications and Image Processing 2005, Proceeding of SPIE, Vol. 5960.

Upon reception of this information, the QAP terminal 105 builds a table of credit indices dedicated to the set of the VBR streams to be transmitted. This table depends on the progress of the predicted bit rate and of the validation time windows. Then, the QAP terminal 105 regulates and redistributes the bandwidth among the different QSTA terminals 101 to 103 according to the delta type TSPEC messages received (described here below) and the table of the credit indices.

FIG. 3 is a flow chart of the essential steps of an algorithm for generating a TSPEC message according to the particular embodiment of the invention. This algorithm is implemented by a QSTA terminal 101, 102, 103 in the context of the transmission of a given VBR stream.

In a step 301, the QSTA terminal verifies that it has received the progress of the predicted bit rate for the transmission of the given VBR stream from the audio-video encoder.

If this is not the case, then the step 301 is again implemented.

If the QSTA terminal has received the progress of the predicted bit rate then, in a step 302, the QSTA terminal analyses the progress of the predicted bit rate (or the progress of the predicted bandwidth).

Then, if there is no need for any modification of the bandwidth for the transmission of the given stream (the bandwidth corresponding for example to the mean bit rate needed to transmit the stream or to the peak bit rates needed to transmit the stream), namely the bandwidth that had been initially reserved through the generation by the QSTA terminal and the transmission to the QAP terminal of an initial standard type TSPEC message, then in a step 308, the algorithm is ended.

The value of the bandwidth initially reserved for the transmission of the stream is also called a reference value of the bandwidth for the transmission of the stream.

In a first mode of implementation of the invention, if a modification of the bandwidth initially reserved for the transmission of the given stream is necessary then, in a step 303, the QSTA terminal samples the progress of the predicted bit rate for the transmission of the given stream in order to define time windows (or time intervals), each being associated with a predicted (or temporary) bit rate value.

The sampling can be done at time intervals that may or may not be regular. The chosen value of the predicted bit rate could, for example, correspond to the maximum value of the bit rate during this interval. The minimum sampling corresponds to the duration of an elementary transmission time interval that can be allocated to a TXOP window.

In another embodiment, the predicted bit rate given by the video encoder could be modelled in the form of a Béziers curve. The TSPEC message will then contain the set of polynomial coefficients characterising the curve. Upon reception of this TSPEC message, the QAP 105 will then be responsible for reconstituting the time windows with their associated predicted bit rate value in performing a sampling of the Béziers curve.

Then, in a step 304, for each time window, the QSTA terminal generates a delta-type TSPEC message in introducing for example a stream identifier, the value of the predicted bit rate in this time window for the transmission of the stream and the time window into at least one reserved field (for example the reserved part of the field “TS Info”) in a standard type of TSPEC message. This delta type TSPEC message could be identified by using an as yet unutilized value of the “Element ID” field.

In one variant of the invention, the QSTA transmits only the difference between the initially reserved value and the predicted value in the delta-type TSPEC message. In a message “Schedule”, the QAP 105 gives the information pertaining to the centralised management of the QOS and gives for example an indication of the start and of the duration of the transmission granted to each stream in a given transmission cycle. On the basis of this information, the QSTA may determine which bandwidth that has been allocated to it for the transmission of a given stream and, from this bandwidth, deduce the reference value (or initially reserved value) for the transmission of this stream.

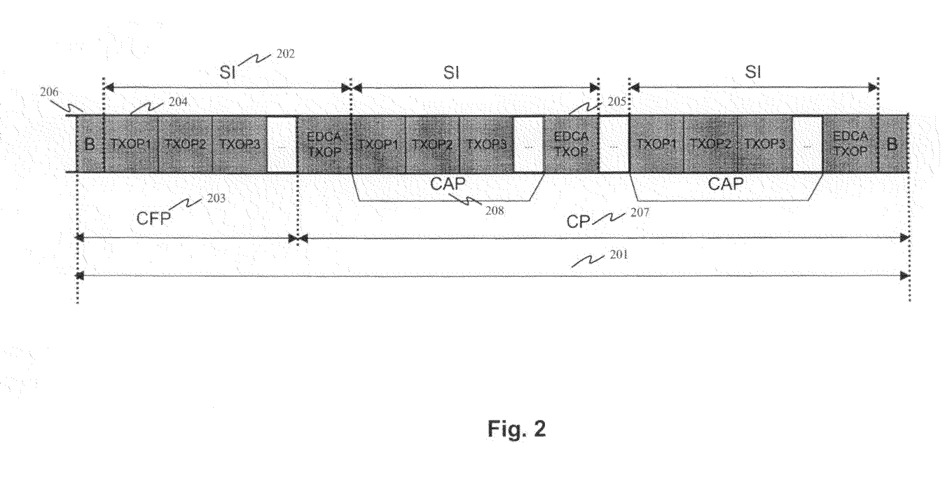

Then, when the delta-type TSPEC message is ready to be sent, in a step 305, the QSTA terminal QTSA sends the delta-type TSPEC message to the QAP terminal 105 during a period 205 dedicated to the EDCA function (as described with reference to FIG. 2).

In a second mode of implementation of the invention, in the step 302, the QSTA terminal analyses the progress of the predicted bit rate in order to determine whether the parameters associated with the stream necessitate modification.

If the progress of the predicted bit rate causes the bandwidth required for the transmission of the given stream to increase permanently relative to the bandwidth initially reserved for the transmission of the VBR stream (for example if the peak value has changed) then in a step 306, the QSTA terminal generates a standard TSPEC message and, in a step 307, the QSTA terminal sends the QAP terminal 105 this standard TSPEC message in order to definitively re-allocate the required bandwidth.

The same method can be applied for a permanent decrease in bandwidth requirements for the transmission of the stream.

When a connection is set up between a source device and one or more sink devices, once the bandwidth requirements for the transmission of the stream have been estimated, the steps 306 and 307 are performed to inform the QAP 105 of the parameters necessary for the centralised setting up of QoS management in the network 1000.

Here below in the description, it is considered to be the case that, after the adaptation of the reference value (or initially reserved value), the new value will be taken as the reference value (or initially reserved value) in the processing associated with the flow charts pertaining to the implementation of the invention.

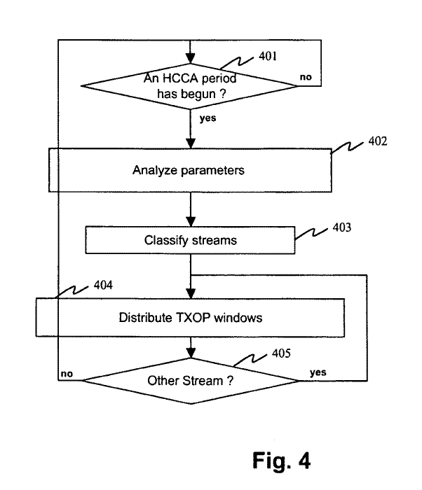

FIG. 4 is a flow chart of the essential steps of the processing algorithm for the processing, by an HCCA type scheduler included in the QAP terminal 105, of a MAC structure (a diagram of which is shown in FIG. 2) according to the particular embodiment of the invention.

In a step 401, the HCCA scheduler checks to see whether a period 208 dedicated to the HCCA function (as described with reference to FIG. 2) has started.

If such a period has not started, then the step 401 is re-implemented.

If such a period has started, then in a step 402, the HCCA scheduler analyses the parameters (which may be for example the size of the window, the bit rate of the stream, the priority of the stream etc.) of each programmed TXOP window.

Then, in a step 403, the scheduler classifies the streams. Then, in a step 404, for a given stream, the HCCA scheduler generates the TXOP windows and gives the “schedule” information needed to inform the QSTAs of the QoS centralised management in the coming transmission cycle.

Then, in a step 405, the scheduler checks to see whether another stream has to be processed. If this is so, the step 404 is re-implemented. If not, the step 401 is re-implemented.

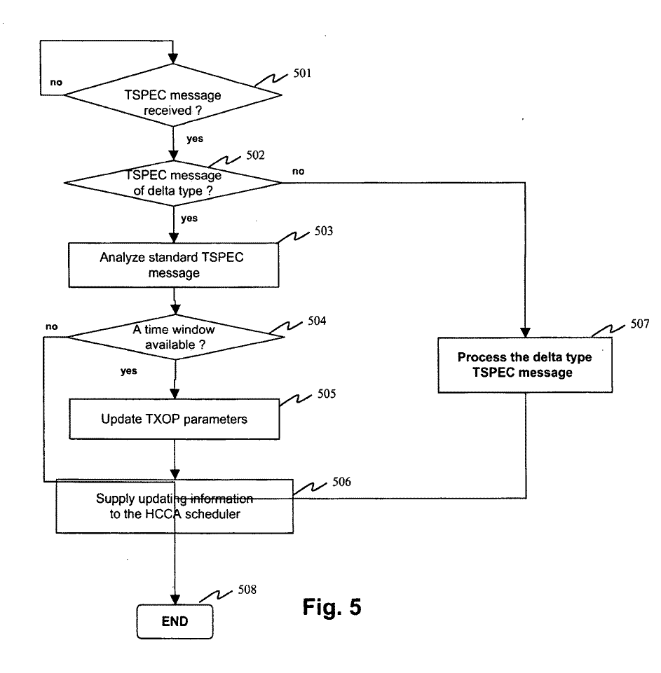

FIG. 5 is a flow chart of the essential steps of a processing algorithm for the processing, by the QAP terminal 105, of a TSPEC message received in the transmission of a given stream according to the particular embodiment of the invention.

In a step 501, the QAP terminal checks to see if it has received a TSPEC message coming from a QSTA terminal for the transmission of a given stream.

If this is not the case, the step 501 is again implemented.

If the QAP terminal has received a TSPEC message, then in a step 502, the QAP terminal checks to see whether the TSPEC message received is a delta-type TSPEC message. To do this, it checks to see whether the “Element ID” field corresponds to the identifier of the delta-type TSPEC message.

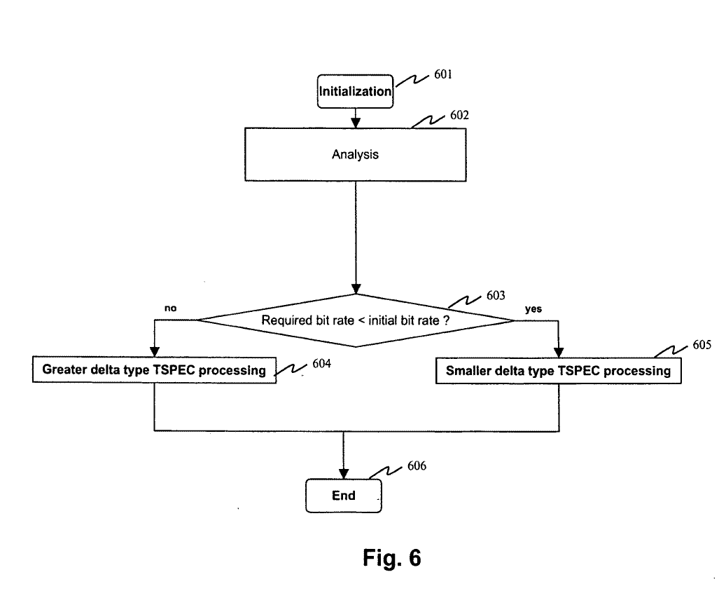

If the received TSPEC message is a delta-type TSPEC message, then in a step 507, a specific processing operation (described here below with reference to FIGS. 6, 7 and 8) is implemented.

If the received TSPEC message is a standard TSPEC message, then in a step 503, the QAP terminal 105 analyses the TSPEC type message in order to obtain the parameters (which are especially the peak and mean values of the predicted bit rate for the transmission of the stream) of the given stream.

Then, in a step 504, the QAP terminal 105 verifies the availability of a time window during a period dedicated to the HCCA function.

If this is not the case, then in a step 508, the algorithm is ended.

If, on the contrary, a time window during a period dedicated to the HCCA function is available, then in a step 505, the QAP terminal 105 updates the parameters (which for example may be the size of the time window, the bit rate of the stream etc.) of each TXOP window (here below called TXOP parameters) associated with the given stream among the streams declared to the QAP terminal 105.

In a preferred mode of implementation of the invention, the parameters of the TXOP time windows associated with the transmission of the stream depend directly on the priority associated with the stream. It is possible to make an initial reservation (or reference reservation) that is proportional to the priority of the stream. Thus, for a high-priority stream, the reservation would be close to the peak value of the bit rate of the stream.

For a low-priority stream, the reservation will be close to the mean value (or even below the mean value) of the bit rate of the stream. Consequently, as will be seen more clearly from the description of the following figures, the QSTA terminal responsible for the transmission of a high-priority stream will send a greater number of smaller delta-type TSPEC messages than larger delta-type TSPEC messages because the bandwidth needs will be generally smaller than the initially reserved value.

Conversely, the QSTA terminal responsible for the transmission of a low-priority stream will send as many larger delta-type TSPEC messages as smaller delta-type TSPEC messages or even more larger delta-type TSPEC messages than smaller delta-type TSPEC messages because the bandwidth needs will be generally greater than the initially reserved value.

In the table of credit indices as described here below with reference to FIG. 9, the high-priority stream as will therefore be favoured in the redistribution of the bandwidth. Thus, once the priority of a stream has been determined, the QAP terminal updates the parameters of each TXOP time window associated with the given stream and takes account of the priority associated with the given stream.

The priority of the stream may be characterised in different ways in the invention. In a first embodiment, and as specified in the IEE802.11e standard, the QSTA terminal gives the QAP terminal the priority of the stream by means of a standardised “TCLAS” type message. This “TCLAS” message defines the class of the audio-video stream and thus enables the QAP terminal to determine the initial value of the bandwidth to be reserved as a function of the class of the stream, i.e. the priority associated with it. In a second embodiment, the QSTA terminal indicates an identical value in the “Minimum Data Rate”, “a Mean Data Rate” and “Peak Data Rate” fields of the TSPEC message. This identical value corresponds to the reference value which the QSTA terminal will have determined according to the priority of the stream to be transmitted.

Then, in a step 506, the QAP terminal 105 gives updating information to the HCCA scheduler (this information will be taken into account for the next MAC structure).

FIG. 6 is a flow chart of the essential steps of the above-mentioned specific processing step 507 for the processing of a delta-type TSPEC message received in the context of the transmission of the given data stream according to the particular embodiment of the invention.

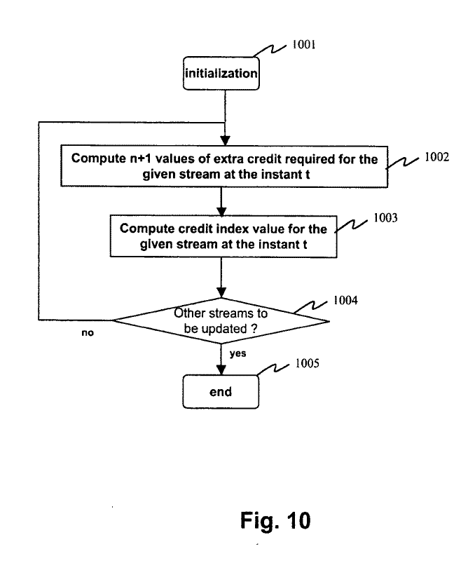

In a resetting step 601, the QAP terminal 105 creates several variables to manage the reception of the delta-type TSPEC message including especially:
the credit index proper to the given stream which is stored in the table of the credit indices (one credit index being stored in the tables for each stream). The value of the credit index at a given instant for a stream reflects the difference between the bandwidth initially reserved for the stream and the bandwidth effectively used for this stream at the given instant (FIG. 9 illustrates an example of implementation of a credit index of this kind and FIG. 10 illustrates an example of computation and updating of the value of this index);
the unutilized bandwidth whose value corresponds to the sum of the values of the unutilized bandwidth for each stream. This variable is used to redistribute the unutilized bandwidth to streams needing more bandwidth or to streams to be transmitted.

Then, in a step 602, the QAP terminal 105 analyses the delta-type TSPEC message received in order to obtain especially an identifier of the given stream (hereinafter referenced “streamlD”), the bit rate required (or predicted) for the transmission of the given stream, a time window to which the required (or predicted) bit rate will be applied and the value of the concerned time window.

In one variant of the invention, the time window is predetermined and the bit rate is predicted over a period equal to the predetermined time window.

Then, in a step 603, the QAP terminal 105 compares the value of the bit rate required for the given stream with the value of the bit rate initially declared for the given stream.

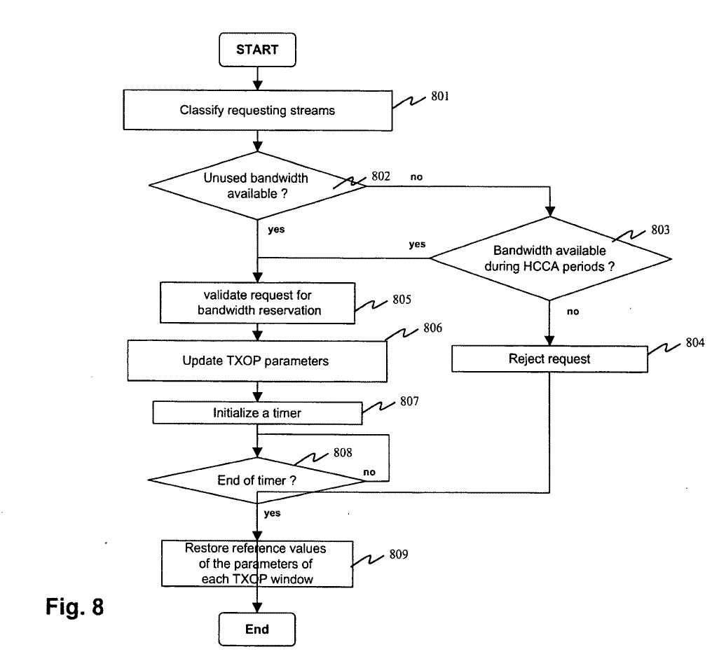

If the value of the bit rate required for the given stream is greater than the initially declared value (or reference value) of the bit rate for the given stream, then the TSPEC message is called a greater delta-type TSPEC message and in a step 604 (described here below with reference to FIG. 8), the QAP terminal implements a processing operation dedicated to the greater delta-type TSPEC message.

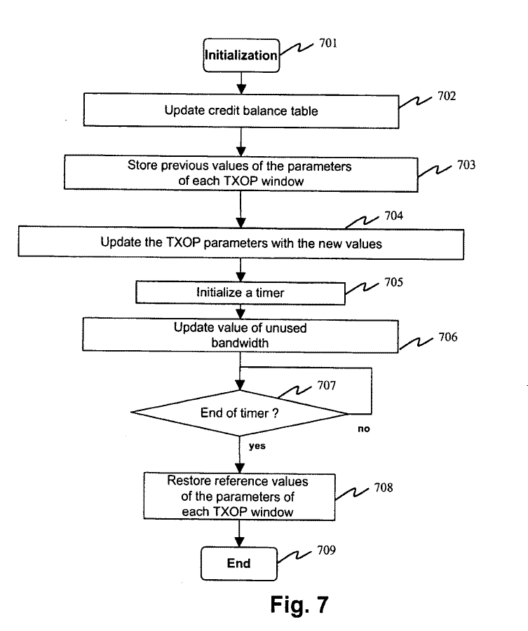

If the value of the bit rate required for the given stream is lower than the value of the bit rate initially declared for the given stream, then the TSPEC message is called a smaller delta-type TSPEC message and, in a step 605 (described here below with reference to FIG. 7), the QAP terminal implements a processing operation dedicated to the smaller delta-type TSPEC message.

Then, in a step 606, the algorithm is ended.

FIG. 7 is a flow chart of the essential steps of the above-mentioned step 605 for the processing of a smaller delta-type TSPEC message received in the context of the transmission of the given stream according to the particular embodiment of the invention.

The smaller delta-type TSPEC message corresponds to the case where the required bit rate is lower than the bit rate initially declared for the transmission of the given stream. Thus, the QAP terminal 105 validates the temporary bandwidth reservation request (of the smaller delta-type TSPEC message) for the duration of the time window associated with the given stream.

In a step 701, the algorithm is reset by the QAP terminal 105.

Then, in a step 702, the QAP terminal 105 updates the credit indices table (as explained here below with reference to FIGS. 10 and 11).

Then, in a step 703, the QAP terminal 105 stores the previous values of the parameters of each TXOP window associated with the given stream.

In a step 704, the QAP terminal 105 updates the TXOP parameters with the new values and transmits these values to the HCCA scheduler.

Then, in a step 705, the QAP terminal 105 initializes a timer corresponding to the time window associated with the given stream as soon as the new bandwidth is validated.

Then, in a step 706, the QAP terminal 105 also updates the unutilized bandwidth value so that the other streams can benefit from this unutilized bandwidth during the time window.

Then, in a step 707, the QAP terminal 105 checks to see whether the timer has elapsed. If this is not the case, then the step 707 is implemented again.

If the timer has elapsed, then in a step 708, the QAP terminal restores the reference (or initial) values of the parameters of each TXOP window associated with the given stream. Then, the algorithm is ended in a step 709.

FIG. 8 is a flow chart of the essential steps of the above-mentioned step 604 for the processing of an upper delta-type TSPEC message received in the transmission of the given stream according to the particular embodiment of the invention.

The upper delta-type TSPEC message corresponds to the case where the required bit rate is greater than the bit rate initially declared for the transmission of the given stream.

Before the processing of all the requests for additional bandwidth, each corresponding to an upper delta-type TSPEC message, all the upper-delta type TSPEC messages must be received in order to implement a hierarchically organised redistribution of the unutilized bandwidth. For example, this algorithm is synchronised with the start of the IEEE802.11e structure as already described with reference to FIG. 2.

In a step 800, the algorithm is reset by the QAP terminal 105.

Then, in a step 801, the QAP terminal 105 classifies the streams requiring more bandwidth according to the value of their credit index in the table of credit indices.

In a preferred mode of implementation of the invention, already explained with reference to FIG. 5, the value of the bandwidth initially reserved for the transmission of a given stream depends directly on the priority associated with this stream. Thus, the QSTA terminal responsible for the transmission of a low-priority stream will send as many greater delta-type TSPEC messages as smaller delta-type TSPEC messages or even more greater delta-type messages and the QSTA terminal responsible for the transmission of a highly-priority stream will send more smaller delta-type TSPEC messages than greater delta-type TSPEC messages. The value of the credit index of a stream depends on the number of smaller delta-type TSPEC messages and greater delta-type TSPEC messages generated for the transmission of the given stream. Thus, a high-priority stream will be favoured in the classification set up at the step 801 and, consequently, the request for additional bandwidth for the transmission of the high-priority stream will be favoured over the requests for additional bandwidth for the transmission of a lower-priority stream.

In a step 802, the QAP terminal 105 checks to see whether the unutilized bandwidth released following the reception of smaller delta-type TSPEC messages is available. The QAP 105 thus first of all uses the bandwidth that has been temporarily released for smaller needs for the transmission of other streams on the network 1000.

If no unutilized bandwidth released following the reception of smaller delta-type TSPEC messages is available then, in a step 803, the QAP terminal 105 checks to see whether bandwidth is available during periods dedicated to the HCCA function. If this is not the case, then in a step 804, the request of the greater delta-type TSPEC is rejected. Then the algorithm is ended in a step 810.

If unutilized bandwidth released following the reception of smaller delta-type TSPEC messages is available or if bandwidth is available during periods dedicated to the HCCA function then, in a step 805, the QAP terminal 105 validates the request for reservation of temporary bandwidth (from the greater delta-type TSPEC message) for the duration of the time window associated with the given stream, and then it updates the table of credit indices.

Then, in a step 806, the QAP terminal 105 stores the previous values of the parameters of each TXOP slot associated with the given stream and updates the TXOP parameter with the new values and transmits these values to the HCCA scheduler.

Then, in a step 807, the QAP terminal 105 initialises the timer corresponding to the time window associated with the given stream as soon as the new bandwidth is valid.

Then, in a step 808, the QAP terminal 105 checks to see whether the timer has elapsed. If this is not the case, then the step 808 is implemented again.

If the timer has elapsed then, in a step 809, the QAP terminal restores the reference values (or initial values) of the parameters of each TXOP slot associated with the given stream. Then, the algorithm is ended in a step 810.

FIG. 9 presents an example of implementation of the table of credit indices according to the particular mode of implementation of the invention.

This table of credit indices is filled and updated by the QAP terminal 105. It comprises:
a first column 901 comprising, for each stream to be transmitted (associated with a row of the table), the value of the credit index of this stream at the instant “t”;
a second column 902 comprising, for each stream to be transmitted, the value of the identifier “streamID” of the stream;
“n+1” (“n” being a natural integer greater than or equal to 1) third columns 903 comprising, for each stream to be transmitted, respectively the value of the difference between the required bit rate and the bit rate initially planned for this stream at the instant “t” (referenced by “extra_credit(t)”), then at the instant “t−1” (referenced by “extra_credit(t−1)”), then at the instant “t−2” . . . , then at the instant “t−n” (referenced by “extra_credit(t−n)”), obtained because of the last delta-type TSPEC messages associated with this stream and received on the “n” last transmission cycles of the network 1000. One variant consists in referencing the “n” last received delta-type TSPEC messages associated with this stream in correspondence with an identifier of the cycle at which each message has been received. Thus the credit index can be computed either as a function of the progress on “n” cycles or as a function of the progress on the “n” last delta-type TSPEC messages received.

FIG. 10 is a flow chart of the essential steps of an algorithm for the updating of the table of credit indices by the QAP terminal according to the particular embodiment of the invention.

The table of credit indices comprises all information pertaining to the values of difference between the required bit rates and the bit rates initially planned for all the other streams at all instants. Each time that a delta type TSPEC for the transmission of a stream is received by the QAP terminal 105, the credit index associated with this stream is updated according to the algorithm described here below. This updating operation could also be done at each cycle, independently of the reception of the delta-type TSPEC messages.

Furthermore, in one variant of the invention, the only messages taken into account in determining the credit index associated with each stream are the delta type messages for which the request for bandwidth adjustment relative to the initial value (or reference value) has been accepted. A bit rate required for the transmission of the stream may have a value greater than the value of bandwidth remaining in the time intervals for which the required bit rate is applied. In this case, the request from the QSTA will be rejected by the QAP 105 and the QSTA will have to degrade the data to be transmitted (should the transfer rate of the data have priority over the integrity of the data) or delay the data to be transmitted (should the integrity of the data have priority over the transfer rate of the data) and thus ensure a bit rate equal to the initial (or reference) value and not to the required bit rate. This variant of the invention therefore makes it possible to avoid assigning the delta type messages to the credit index for which the bandwidth adjustment has not been made.

In a step 1001, the updating algorithm is initialised by the QAP terminal 105 for example at the reception of a delta type TSPEC message for the transmission of the given stream.

Then, in a step 1002, the QAP terminal 105 computes the “n+1” values of difference between the required bit rate and the bit rates initially planned for this stream respectively at the instants “t”, “t−1”, . . . , “t−n”.

For these computations of the “extra_credit( )” parameters, a bit rate value for a stream at an instant “t” is taken to be equal to the product of the bit rate at the instant “t” multiplied by the duration of the time window associated with the transmission of the given stream at the instant “t”.

Then, in a step 1003, the QAP terminal 105 computes the value of the credit index associated with the given stream at the instant “t” (referenced “credit_index(t)”) according to the following formula:

$$credit\_index ( t ) = extra\_credit ( t ) + {\sum }_{i = 0}^{n} extra\_credit ( t - i ) / ( i + 1 )$$

Then, in a step 1004, the QAP terminal 105 checks to see whether the table must be updated for another stream. If this is the case, then the steps 1002 and 1003 are re-implemented for this other stream. If not, the algorithm is ended in a step 1005.

Naturally, other techniques may be implemented in the context of the present invention for updating the tables of credit indices.

1. A method for managing resources for transmissions compliant with a communications protocol, in a communications network, for transmitting a first data stream between a source device and at least one sink device, said method being implemented by a manager device and comprising steps of:
making a first allocation of a first value, called a reference value, of bandwidth for transmission of the first data stream;
obtaining a piece of information representing a first temporary value of bandwidth for transmission of the first data stream, associated with a relevance time interval;
making a second allocation, for a duration equal to the relevance time interval, of a second value, called a validated value, of bandwidth for transmission of the first data stream dependant on the reference value and the first temporary value of the bandwidth for transmission of the first data stream;
making available, for transmission of the first data stream after expiration of the relevance time interval, an amount of bandwidth equal to at least the reference value.

2. A resource management method according to claim 1, further comprising a step of determining the validated value, wherein, if the first temporary value is lower than the reference value, then the validated value is equal to the first temporary value.

3. A resource management method according to claim 2, wherein a difference between the reference value and the first temporary value is added to a value of bandwidth unutilized in the network during the relevance time interval.

4. A resource management method according to claim 2, wherein, if the first temporary value is greater than the reference value, then the step of determining the validated value includes a step of determining a bandwidth value, called a difference value, equal to a difference between the first temporary value and the reference value.

5. A resource management method according to claim 4, further comprising a step of determining a value of bandwidth unutilized in the network in said relevance time interval.

6. A resource management method according to claim 5, wherein said step of determining a value of bandwidth unutilized in said relevance time interval includes a preliminary step of obtaining at least one piece of information representing at least one second temporary value of bandwidth for transmission of at least one second data stream in said relevance time interval.

7. A resource management method according to claim 5, wherein said step of determining the validated value is performed according to a policy of redistribution of said value of bandwidth unutilized in the network in said relevance time interval, said policy taking account of a value of classification associated with each stream being transmitted in the network.

8. A resource management method according to claim 7, wherein, for a given stream, said value of classification is obtained from at least one piece of information representing a difference between the reference value and at least one validated value, for a given time interval, of bandwidth for transmission of said given stream.

9. A resource management method according to claim 8, wherein said value of classification of the given stream is increased when the first temporary value is greater than the reference value for transmission of said given stream.

10. A resource management method according to claim 6, wherein, for a given stream, a value of classification is obtained from at least one piece of information representing a difference between the reference value and at least one validated value, for a given time interval, of bandwidth for transmission of said given stream.

11. A resource management method according to claim 8, wherein said value of classification of said given stream is reduced when the first temporary value is less than the reference value for transmission of said given stream.

12. A resource management method according to claim 7, wherein the validated value is equal to the first temporary value, if the difference value is less than said value of bandwidth unutilized in the network in said relevance time interval, that is remaining once each stream undergoing transmission in the network, whose value of classification is greater than that of the first data stream, has been taken into account in a step of redistributing said value of bandwidth unutilized in the network in said relevance time interval.

13. A resource management method according to claim 1, wherein said piece of information representing the first temporary value of bandwidth is computed by the manager device according to a piece of information representing a predicted value of bandwidth, said piece of information representing a predicted value of bandwidth being transmitted to the manager device by the source device.

14. A resource management method according to claim 1, wherein said piece of information representing the first temporary value of bandwidth is computed by the source device according to a piece of information representing a predicted value of bandwidth, and then said piece of information representing the first temporary value of bandwidth is transmitted to the manager device.

15. A resource management method according to claim 2, wherein the reference value depends on a level of transmission priority associated with said first data stream.

16. A resource management method according to claim 1, wherein the communications protocol is an IEEE 802.11e protocol, the manager device is a QAP terminal, and the source device is a QSTA terminal.

17. A computer-readable storage medium storing a set of instructions that, when executed by a computer, implements a method for managing resources for transmissions compliant with a communications protocol, in a communications network, for transmitting a first data stream between a source device and at least one sink device, wherein said method includes steps of:
making a first allocation of a first value, called a reference value, of bandwidth affected by transmission of the first data stream;
obtaining a piece of information representing a first temporary value of bandwidth for transmission of the first data stream, associated with a relevance time interval;
making a second allocation, for a duration equal to the relevance time interval, of a second value, called a validated value, of bandwidth for transmission of the first data stream dependant on the reference value and the first temporary value of bandwidth for transmission of the first data stream;
making available, for transmission of the first data stream after expiration of the relevance time interval, an amount of bandwidth equal to at least the reference value.

18. A manager device comprising managing means for managing resources for transmissions compliant with a communications protocol, in a communications network, for transmitting a first data stream between a source device and at least one sink device, said managing means including:
first means for allocating a first value, called a reference value, of bandwidth affected by transmission of the first data stream;
means for obtaining a piece of information representing a first temporary value of bandwidth for transmission of the first data stream, associated with a relevance time interval;
second means for allocating, for a duration equal to the relevance time interval, of a second value, called a validated value, of bandwidth for transmission of the first data stream dependant on the reference value and the first temporary value of bandwidth for transmission of the first data stream;
means for making available, for transmission of the first data stream after expiration of the relevance time interval, an amount of bandwidth equal to at least the reference value.

19. A manager device according to claim 18, wherein said managing means further includes means for determining the validated value, wherein, if the first temporary value is less than the reference value, then the validated value is equal to the first temporary value.

20. A manager device according to claim 19, wherein said managing means further includes means for adding a difference between the reference value and the first temporary value to a value of bandwidth unutilized in the network during the relevance time interval.

21-34. (canceled)
